(19) United States
(12) Patent Application Publication
(10) Pub. No.: US 2015/0230449 A1
(43) Pub. Date: Aug. 20, 2015

(54) Fire Ant Killer Application Device

(71) Applicant: Roger Young, Pulaski, TN (US)

(72) Inventor: Roger Young, Pulaski, TN (US)

(21) Appl. No.: 14/182,143

(22) Filed: Feb. 17, 2014

(51) Int. Cl. A01M 1/20; A01M 17/00

(52) U.S. Cl. CPC A01M 1/20; A01M 17/00

(57) ABSTRACT

The device for applying fire ant killer granules to fire ant hills has an applicator coupled to a container of fire ant granules. The applicator has a straight portion of tubing with an open end and a closed end. An angled tube extends from the straight portion of tubing near the closed end. The container is releasably coupled to the angled tube. A user inverts the applicator to load a fixed amount of fire ant killer granules into the straight portion, and inverts the applicator a second time to release the fixed amount of granules from the open end of the straight portion of the applicator.

### BACKGROUND AND SUMMARY OF THE INVENTION

Fire ants are aggressive ants with painful stings, and are the bane of many homeowners. Homeowners out mowing the grass may notice fire ant hills and mentally note their location for later application of ant killer. However, when dealing with large properties with a large number of ant hills, it would be helpful to have fire ant killer that is capable of being applied from the user's position on a riding mower, for example. This way the homeowner can apply the ant killer without getting off the mower.

A device for applying fire ant killer granules to fire ant hills has an applicator coupled to a container of fire ant granules. The applicator has a straight portion of tubing with an open end and a closed end. An angled tube extends from the straight portion of tubing near the closed end. The container is releasably coupled to the angled tube. A user inverts the applicator to load a fixed amount of fire ant killer granules into the straight portion, and inverts the applicator a second time to release the fixed amount of granules from the open end of the straight portion of the applicator.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

The disclosure can be better understood with reference to the following drawings. The elements of the drawings are not necessarily to scale, emphasis instead being placed upon clearly illustrating the principles of the disclosure. Furthermore, like reference numerals designate corresponding parts throughout the several views.

FIG. 1 is a side view of a device for applying fire ant killer granules according to an exemplary embodiment of the disclosure.

FIG. 2 is an inverted view of the device of FIG. 1.

FIG. 3 depicts the device of FIG. 1 being grasped by a user.

FIG. 4 depicts the device of FIG. 1 applying fire ant killer granules onto an ant hill.

FIG. 5 depicts an alternative embodiment of the device of FIG. 1 coupled to a hanging bracket.

FIG. 6 is an end view of a hanging bracket.

FIG. 7 is a side plan view of the hanging bracket of FIG. 6.

FIG. 8 is a rear plan view of the hanging bracket of FIG. 7.

FIG. 9 depicts the device of FIG. 5 rotated on the hanging bracket to a secured position.

### DETAILED DESCRIPTION

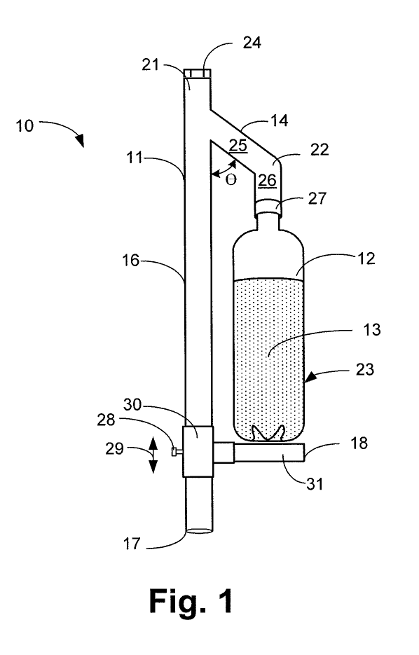

FIG. 1 depicts an embodiment of a device 10 for applying ant killer granules 13 on ant hills (not shown). The device comprises an applicator 11 which is releasably affixed to a container 12, the container 12 containing ant killer granules 13. The ant killer granules 13 are any of a number of granular, commercially-available ant killers. The applicator 11 is formed from PVC pipe and fittings in one embodiment, but could alternatively be formed from other materials.

The container 12 comprises a reservoir portion 23 and an opening (not shown). The reservoir portion 23 of the container 12 contains the ant killer granules 13. The opening of the container 12 is threaded with standard male threads (not shown) in one embodiment. In the illustrated embodiment, the container 12 is formed from transparent plastic. The container 12 comprises a standard commercially-available plastic bottle in this embodiment, though other containers could be used in the alternative.

The applicator 11 comprises a substantially straight and substantially hollow tube 16 with an opening 17 on one end and a closed end 21 on the opposite end. The closed end 21 comprises a removable cap 24 in the illustrated embodiment. An arm 14 extends from the tube 16 near the closed end 21 of the applicator 11. The arm 14 is formed from substantially hollow tubing and comprises an angled portion 25 and a straight portion 26. In the illustrated embodiment, the angled portion 25 of the arm 14 extends from the tube 16 an angle “Θ” of around 45 degrees with respect to the tube 16. Other angles may be used in the alternative, provided, however, that the angle Θ should be less than 90 degrees.

The straight portion 26 of the arm 14 is generally parallel to the tube 16. The straight portion 26 of the arm 14 comprises a coupler 27 for coupling with the container 12. In this regard, the opening (not shown) of the container 12 releasably couples to the coupler 27. In the illustrated embodiment, the coupler 27 comprises standard female threads (not shown) which couple with the male threads (not shown) of the container 12. In other embodiments, coupling means other than threads may be used on the container 12 and the coupler 27.

A container support 18 extends from the applicator 11 and supports the container 12 on its lower end. In the illustrated embodiment, the container support 18 comprises a T-shaped fitting 30 that adjustably slides over the tube 16 in the direction indicated by directional arrow 29, i.e., aligned with a longitudinal axis (not shown) of the tube 16. A support arm 31 extends from the fitting 30 and is contactable with a bottom side 32 of the container 12. The support arm 31 is formed from generally cylindrical tubing in one embodiment. A thumb screw 28 “locks” the fitting 30 to the tube 16 when the support 18 is in the desired position. Some embodiments of the device 10 do not contain a container support 18; for example, the coupler 27 coupling with the container 12 may sufficiently support the container 12 to the applicator 11. In other embodiments the container support 18 is differently configured. In some embodiments, a support strap (not shown) wraps around the container 12 and the tube 16 to retain the container 12 to the tube 16.

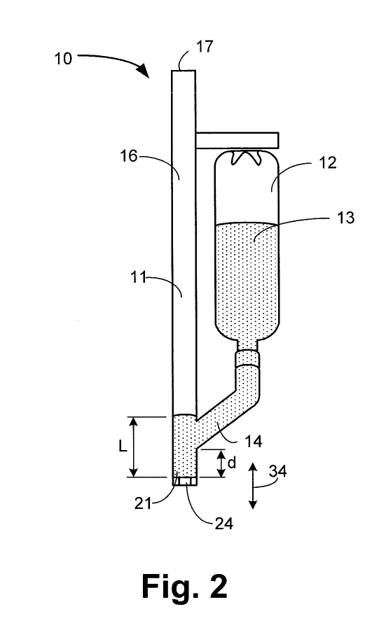

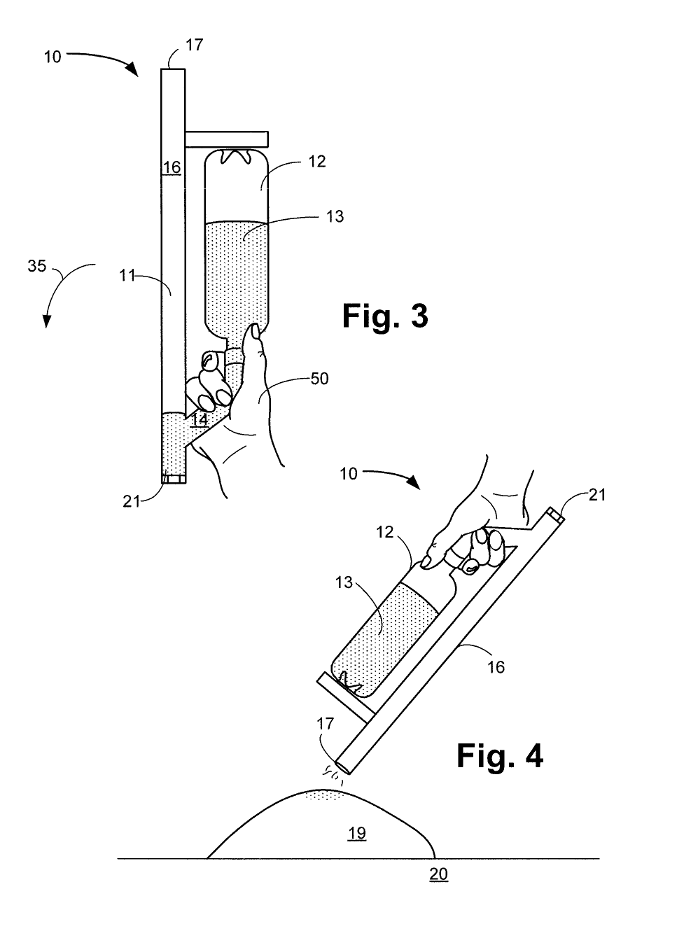

FIG. 2 depicts the device 10 in an inverted position. The user puts the device 10 in this position to prepare the device 10 for dispensing fire ant killer granules 13, i.e., to “load” the granules 13 into the tube 16. This inverted position is sometimes referred to herein as the “loading position.” When the device 10 is in the loading position, gravity causes the ant killer granules 13 in the container 12 to fall down into the closed end 21 of the applicator 11. (Note that portions of the applicator 11 are illustrated in FIGS. 2 and 3 as transparent to show the granules 13 in the applicator; in reality the applicator may not be transparent.) The ant killer granules 13 fill the closed end 21 up to a level “L” in a fixed amount that is set by the diameter of the tube 16 and the distance “d” between the closed end 21 and the angled portion 25 of the arm 14. The amount of the granules in the fixed amount is set at 1 tablespoon in one embodiment.

The distance “d,” and thus the fixed amount, can be varied by the design of the device 10. In some embodiments, the distance “d” and the fixed amount can be varied by adjusting the cap 24. In this regard, in some embodiments the cap 24 is adjustable, and, for example, tightening the cap decreases the distance “d” and loosening the cap 24 increases the distance “d.” By adjusting the cap in the direction indicated by directional arrow 34, the fixed amount can be increased or decreased.

In one embodiment, the cap 24 comprises a threaded rod (not shown) and a nut (not shown). The threaded rod can be advanced or loosened within the end of the tube 16 until it is in a desired position, and the nut is tightened to set the position of the threaded rod. This is one option for varying the fixed amount of granules 13 to be administered.

In another embodiment, the cap 24 comprises a solid rod with a flat side (not shown), and a thumb screw (not shown) tightened against the solid rod sets the position of the cap 24. Other embodiments may use other means for varying the fixed amount.

FIG. 3 depicts the device 10 being grasped by a hand 50 of the user in the loading position. The user's hand 50 grasps the arm 14 of the applicator 11 to load the granules 13. From this loading position, the user may then invert the device 10 again to dispense the granules 13. The device 10 should be inverted in the direction shown by directional arrow 35, in order to properly dispense the granules 13 from the tube 16.

FIG. 4 depicts the device 10 dispensing granules 13 on an ant hill 19. Inverting the device 10 after the device 10 has been in the loading position causes some of the granules 13 to fall back into the container 12, and causes the fixed amount of granules to fall out of the opening 17. When the user grasps the device 10 near the closed end 21 as shown, the hollow tube 16 is generally long enough that the opening 17 of the tube will dispense the granules 13 near the ground 20. In this manner, the user who may be mowing the lawn can dispense the fixed amount of ant killer granules 13 quickly and easily without leaving the mower, and can continue with cutting the lawn.

The device 10 according to the present disclosure has an advantage in that it has no moving parts, e.g., no valves are required to open or close during operation of the device. The granules are loaded into the device 10 and dispensed using the force of gravity.

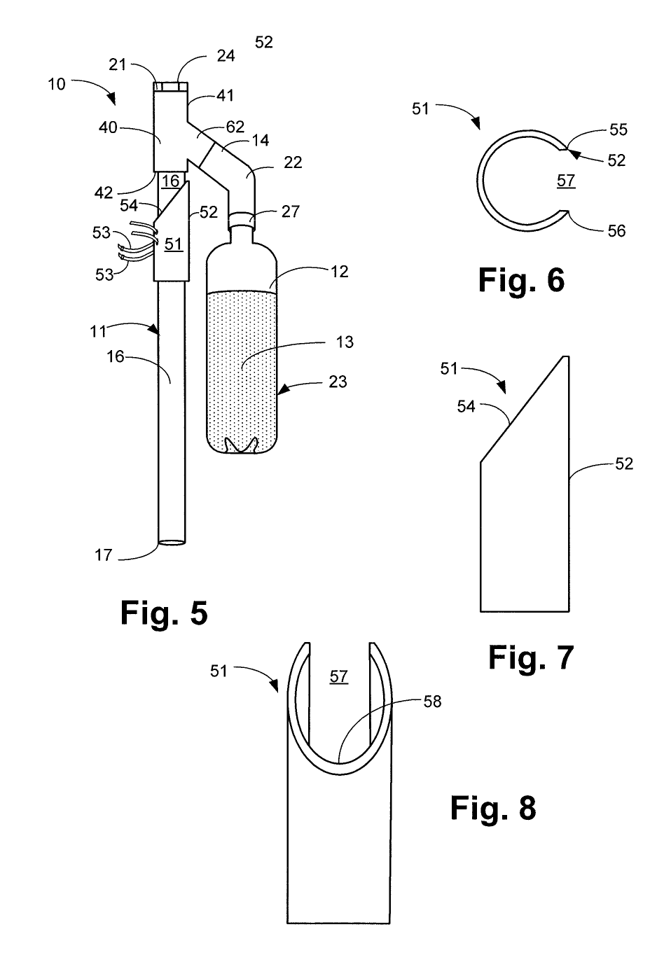

FIG. 5 depicts an alternative embodiment of the device 10 of FIG. 1. In this embodiment, a Y-shaped fitting 41 is disposed on the closed end 21 of the applicator 11. The Y-shaped fitting 41 comprises a straight portion 40 that is concentric with and receives the tube 16. In this regard, the straight portion 40 is slightly larger in inner diameter than an outer diameter of the tube 16, such that the tube 16 fits within the straight portion 40, creating a lip 42 between the outer diameter of the straight portion 40 and the tube 16. In this embodiment, the Y-shaped fitting comprises a standard PCV Y-shaped fitting.

The Y-shaped fitting further comprises an angled portion 62 that is concentric with and couples to the arm 14. In this embodiment, the arm 14 comprises a standard angled PVC elbow.

A bracket 51 is releasably coupled to the tube 16 of the applicator 11 in this embodiment. The device 10 may be removably attached to a lawn mower via the bracket 51 such that the device 10 is releasably retained by the bracket. When the user comes across an ant hill in need of treatment, the user can stop the mower and, without getting up from the mower seat, grasp the device 10 and load and apply the granules as discussed with respect to FIGS. 2-4.

The bracket 51 comprises a C-shaped tube with an open end 52 that slides over the tube 16 to releasably couple the bracket 51 to the tube 16. An inner diameter of the bracket 51 is slightly larger than the outer diameter of the tube 16, such that the applicator is retained with the bracket 51, and is generally free to rotate within the bracket 51. The lip 42 prevents the applicator 11 from sliding through the bracket 51. An upper edge 54 of the bracket 51 is angled in the illustrated embodiment.

A fastener 53 is affixed to the bracket 51 and may couple the bracket 51 to the mower (not shown). In one embodiment, the fastener 53 comprises one or more zip ties. In other embodiments, other forms of fastening devices may be used to couple the bracket 51 to the mower.

FIG. 6 is an end view of the bracket 51 of FIG. 5. The bracket 51 is formed from generally cylindrical tubing with an open end 52 that forms a space 57 between “cut ends” 55 and 56 of the bracket 51. The bracket 51 thus forms a C-shape when viewed from the end. The space 57 is sized sufficiently large that the bracket 51 can slide over the tube 16 (FIG. 5).

FIG. 7 is a side view of the bracket 51 of FIG. 5. The upper edge 54 is cut at an angle as shown. In one embodiment, the angle of the upper edge 54 is generally the same as the angle Θ of the arm 14 (See FIG. 1).

FIG. 8 is rear side view of the bracket 51 of FIG. 5. Because the upper edge 54 of the bracket is cut at an angle, a crook 58 is formed in the bracket.

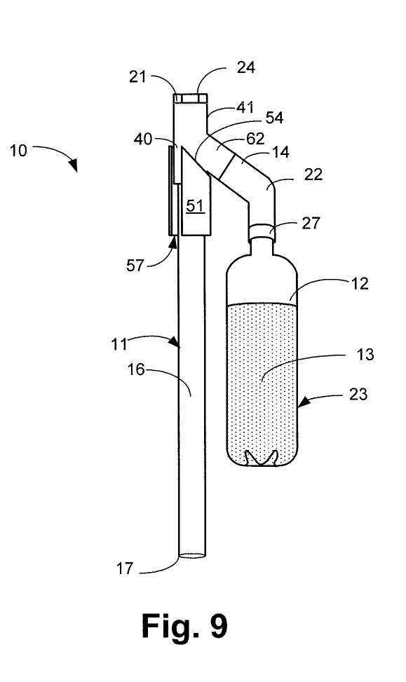

FIG. 9 depicts the applicator 11 hanging from the bracket 51 of FIG. 5. After the applicator 11 is hung on the bracket 51, the applicator 11 may rotate within the bracket 51 such that intersection between the straight portion 40 and the angled portion 41 of the Y-shaped fitting rests in the crook 58 (FIG. 8) of the bracket 51. The shape of the bracket 51 thus aids in releasably securing the applicator 10 to the mower.

1. A device for applying fire ant killer granules, the device comprising:
an applicator comprising
a straight portion of tubing, the straight portion of tubing comprising an open end and a closed end, and
an angled tube extending from the straight portion of tubing near the closed end;
a container releasably coupled to the angled tube, the container configured to contain fire ant granules;
wherein a first inversion of the applicator by a user causes a fixed amount of granules from the container to enter the straight portion, and a second inversion of the applicator by the user causes the fixed amount of granules to be released from the open end of the straight portion of tubing.

2. The device of claim 1, wherein the container comprises a male threaded opening and the angled tube comprises a female threaded opening configured to receive the male threaded opening.

3. The device of claim 1, wherein the container comprises a substantially transparent plastic bottle.

4. The device of claim 1, further comprising a container support extending from and adjustably coupled to the straight portion of tubing, the container support contactable with a bottom of the reservoir to support the container.

5. The device of claim 1, wherein the angled tube is disposed at an angle with respect to the straight portion of tubing, the angle less than 90 degrees.

6. The device of claim 5, wherein the angle is 45 degrees or less.

7. The device of claim 1, further comprising a support strap extending between the container and the straight portion of tubing.

8. The device of claim 1, wherein the fixed amount of granules is adjustable by adjusting a position of a cap on the closed end, whereby decreasing the distance between the cap and the open end increases the fixed amount and decreasing the distance between the cap and the open end decreases the fixed amount.

9. A device for applying fire ant killer granules, the device comprising:
a container comprising a reservoir for containing granules, the container further comprising an opening for releasing granules;
a substantially hollow applicator, the applicator comprising a straight portion with a closed end and an open end, the applicator further comprising an arm extending from the straight portion, the arm comprising substantially hollow tubing, the arm further comprising an angled portion that is angled with respect to the straight portion at an angle, the arm further comprising a coupler for coupling with the container, wherein inverting the device a first time causes a fixed amount of granules to be loaded into the straight portion of the applicator, and inverting the device a second time causes the fixed amount to be released from the open end of the applicator.

10. The device of claim 9, further comprising a container support extending from and adjustably coupled to the straight portion of the applicator, the container support contactable with a bottom of the reservoir to support the container.

11. The device of claim 10, wherein the container support is adjustable in lined with a longitudinal axis of the straight portion.

12. The device of claim 11, wherein the angle less than 90 degrees.

13. The device of claim 9, wherein the angle is 45 degrees or less.

14. The device of claim 9, further comprising a support strap extending between the container and the straight portion of tubing.

15. The device of claim 9, wherein the fixed amount of granules is adjustable by adjusting a position of a cap on the closed end, whereby decreasing the distance between the cap and the open end increases the fixed amount and decreasing the distance between the cap and the open end decreases the fixed amount.
